(19) United States
(12) Patent Application Publication
(10) Pub. No.: US 2022/0203829 A1
(43) Pub. Date: Jun. 30, 2022

(54) PROJECTION OPTICAL SYSTEM AND HEAD-UP DISPLAY DEVICE MOUNTED ON AUTOMOBILE

(71) Applicant: IVIEW DISPLAYS (SHENZHEN) COMPANY LTD., Shenzhen (CN)

(72) Inventors: Weizhan Zhu, Shenzhen (CN); Xiaofeng Tang, Shenzhen (CN); Mingnei Ding, Shenzhen (CN); Steve Yeung, Hong Kong (CN); Zhiqiang Gao, Hong Kong (CN)

(21) Appl. No.: 17/537,634

(22) Filed: Nov. 30, 2021

Related U.S. Application Data
(63) Continuation of application No. PCT/CN2021/083356, filed on Mar. 26, 2021.

(30) Foreign Application Priority Data
Dec. 28, 2020 (CN) 202011577347.4

(51) Int. Cl. B60K 35/00; G02B 26/08

(52) U.S. Cl. CPC B60K 35/00; G02B 26/0875; B60K 2370/52; B60K 2370/23; B60K 2370/1529

(57) ABSTRACT

A projection optical system applicable to a head-up display device mounted on an automobile includes an image generation unit, a first reflection unit, a light splitting device, a first lens, a second reflection unit, and a second lens that are successively arranged in a light exit direction; and a controller configured to control, based on timing, an image emitted from the connected image generation unit and light exiting from the connected light splitting device; wherein the top view of the light splitting in disc shape includes transmission region and reflection region. The light exits only from the reflection region during the image generation unit emitting the first image and exits only from the transmission region during the image generation unit emitting the second image, such that the first image and the second image are emitted and imaged through the first lens and the second lens.

### CROSS-REFERENCE TO RELATED APPLICATION

This application is based upon and claims priority to Chinese Patent Application No. 202011577347.4, filed before China National Intellectual Property Administration on Dec. 28, 2020 and entitled “PROJECTION OPTICAL SYSTEM AND HEAD-UP DISPLAY DEVICE MOUNTED ON AUTOMOBILE,” the entire contents of which are incorporated herein by reference.

### TECHNICAL FIELD

Embodiments of the present disclosure relate to the technical field of projection optics, and in particular, relate to a projection optical system and a head-up display device mounted on an automobile.

### BACKGROUND

A head-up display (HUD) refers to a display mounted on a front windshield of an automobile. Nowadays, with transformation of the automobile towards intelligence, at present, newly designed intelligent automobiles are all mounted with HUDs, and drivers are capable of knowing speed, speed limitation signs, drive routes and the like vehicle information and road condition information with no need of lowering heads to check instrument panels. Augmented reality HUDs (AR HUDs) are prevailing currently. An AR HUD is a head-up display device capable of displaying AR pictures.

During practice of embodiments of the present disclosure, the applicant has found that the related art has at least the following problem: At present, the HUD, that is, the head-up display device, mounted on the automobile is only capable of displaying a two-dimensional planar picture, for example, a driving information picture of the automobile, or is only capable of displaying an AR picture, for example, a picture displaying road condition information captured by a camera of the automobile. Where these two pictures need to be simultaneously displayed, two head-up display devices are needed. As such, a sufficient space needs to be reserved at the front portion of the body of the automobile to receive two HUDs.

### SUMMARY

With respect to the defects in the related art, objects of embodiments of the present disclosure are to provide a projection optical system capable of projecting and imaging two pictures, and a head-up display device mounted on an automobile.

The objects of the embodiments of the present disclosure are achieved by employing the following technical solutions:

In view of the above technical problem, in a first aspect, the embodiments of the present disclosure provide a projection optical system. The projection optical system includes:

an image generation unit, configured to emit light beams comprising image information of a first image and a second image;

a first reflection unit, wherein a light incident side of the first reflection unit is arranged in a light exit direction of the image generation unit;

a light splitting device, a light incident side of the light splitting device being arranged in a light exit direction of a light reflection side of the first reflection unit, and the light splitting device being in a disc shape in a top view direction and including a transmission region and a reflection region;

a first lens, a light incident side of the first lens being arranged in a light exit direction of a light reflection side of the light splitting device;

a second reflection unit, a light incident side of the first lens is arranged in a light exit direction of a light transmission side of the light splitting device;

a second lens, wherein a light incident side of the second lens is arranged in a light exit direction of a light reflection side of the second reflection unit; and

a controller, connected to the image generation unit and the light splitting device, and configured to control, based on timing, an image emitted from the image generation unit and light exiting from the light splitting device; wherein

the controller is configured to control, in response to controlling the image generation unit to emit the first image, the light to exit from only the reflection region of the light splitting device, such that the first image is emitted and imaged through the first lens, or

the controller is configured to control, in response to controlling the image generation unit to emit the second image, the light to exit only from the transmission region of the light splitting device, such that the second image is emitted and imaged through the second lens.

In some embodiments, the projection optical system further includes:

a first driving device, connected to the controller and the light splitting device, and configured to drive, in response to a control instruction issued by the controller, the light splitting device to rotate.

the light splitting device, in response to rotating to a first angle, is such configured that only the reflection region of the light splitting device is arranged in a light exit direction of the first reflection unit to reflect the light beam of the first image, or

the light splitting device, in response to rotating to a second angle, is such configured that only the transmission region of the light splitting device is arranged in a light exit direction of the second reflection unit to transmit the light beam of the second image.

In some embodiments, in the light splitting device, an area of the transmission region is equal to an area of the reflection region in a top view direction; and

the light splitting device is divided into two transmission regions and two reflection regions, wherein the two transmission regions are arranged in a zig-zag configuration, and the two reflection regions are arranged in a zig-zag configuration,

or,

the light splitting device is divided into one transmission region and one reflection region.

In some embodiments, the reflection region is provided with a highly reflective film configured to reflect the light beam of the first image, and the transmission region is provided with an anti-reflection film configured to transmit the light beam of the second image.

In some embodiments, the first reflection unit is a turning prism, arranged at a first predetermined angle between the image generation unit and the light splitting device; and

the second reflection unit is a mirror arranged at a second predetermined angle between the light splitting device and the second lens.

In some embodiments, the automobile further includes a front windshield, wherein the front windshield is a diffuser, and in the projection optical system, relay images of the first lens and the second lens are imaged on the front windshield; and

the controller is further connected to the first lens and the second lens, and configured to adjust, by controlling positions of the first lens and the second lens, a virtual image distance between the first image and the second image in response to the first image and the second image being imaged on the front windshield.

In some embodiments, the projection optical system further includes:

a second driving device, connected to the controller and the first lens, and configured to drive, in response to a control instruction issued by the controller, the first lens to adjust an imaging position of light exiting from the first lens; and

a third driving device, connected to the controller and the second lens, and configured to drive, in response to a control instruction issued by the controller, the second lens to adjust an imaging position of light exiting from the second lens.

In some embodiments, an optical power of the first lens is 24 mm, and a focal length of the first lens is 15.4 mm; and

an optical power of the second lens is 45 mm, and a focal length of the second lens is 26.4 mm.

In some embodiments, an optical power of the light splitting device is 52 mm.

In view of the above technical problem, in a second aspect, the embodiments of the present disclosure provide a head-up display device mounted on an automobile. The head-up display device includes the projection optical system according to the first aspect, wherein the projection optical system is capable of projecting the first image and/or the second image onto a front windshield of the automobile such that imaging is achieved on the front windshield.

Compared with the related art, the embodiments of the present disclosure achieve the following beneficial effects: The embodiments of the present disclosure provide a projection optical system applicable to a head-up display device mounted on an automobile. The projection optical system includes an image generation unit, a first reflection unit, a light splitting device, a first lens, a second reflection unit, and a second lens that are successively arranged in a light exit direction; and further includes a controller connected to the image generation unit and the light splitting device, and configured to control, based on timing, an image emitted from the image generation unit and light exiting from the light splitting device; wherein the light splitting device is in a disc shape in a top view direction and includes a transmission region and a reflection region; and the controller is configured to control, in response to controlling the image generation unit to emit the first image, the light to exit only from the light reflection region of the light splitting device, such that the first image is emitted and imaged through the first lens, or the controller is configured to control, in response to controlling the image generation unit to emit the second image, the light to exit only from the light transmission region of the light splitting device, such that the second image is emitted and imaged through the second lens. The projection optical system according to the present disclosure is capable of displaying, based on timing control, different contents and pictures at two different positions, and in addition, the system has advantages of small size and low cost.

### BRIEF DESCRIPTION OF THE DRAWINGS

One or more embodiments are illustrated by way of example, and not by limitation, in the figures of the accompanying drawings, wherein elements/modules and steps having the same reference numeral designations represent like elements/modules and steps throughout. The drawings are not to scale, unless otherwise disclosed.

FIG. 1 is a schematic diagram of an application scenario of a projection optical system according to an embodiment of the present disclosure;

FIG. 2 is a schematic diagram of imaging on a front windshield in the application scenario in FIG. 1;

FIG. 3 is a schematic structural diagram of a projection optical system according to a first embodiment of the present disclosure;

FIG. 4 is a schematic diagram of an optical path in the projection optical system in FIG. 3;

FIG. 5 is a schematic structural block diagram of electrical connection of the projection optical system according to the first embodiment of the present disclosure;

FIG. 6 is a schematic structural diagram of a first light splitting device according to the first embodiment of the present disclosure;

FIG. 7 is a schematic top view of the light splitting device in FIG. 6;

FIG. 8 is a schematic structural diagram of a second light splitting device according to the first embodiment of the present disclosure;

FIG. 9 is a schematic top view of the light splitting device in FIG. 8; and

FIG. 10 is a schematic structural diagram of a head-up display device mounted on an automobile according to a second embodiment of the present disclosure.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

For clearer descriptions of the objectives, technical solutions, and advantages of the present disclosure, the present disclosure is further described with reference to specific embodiments and attached drawings. It should be understood that the specific embodiments described herein are only intended to explain the present disclosure instead of limiting the present disclosure.

It should be noted that, in the absence of conflict, embodiments of the present disclosure and features in the embodiments may be incorporated, which all fall within the protection scope of the present disclosure. In addition, although function module division is illustrated in the schematic diagrams of apparatuses, and in some occasions, module division different from the divisions of the modules in the apparatuses may be used. Further, the terms “first,” “second,” and the like used in this text do not limit data and execution sequences, and are intended to distinguish identical items or similar items having substantially the same functions and effects.

For ease of definition of the connection structure, positions of the components are defined using a light exit direction of a light beam as a reference. As used herein, the terms “upper,” “lower,” “left,” “right,” “vertical” “horizontal,” and the like expressions are used for illustration purposes only. For ease of definition of the connection structure, positions of the components are defined using a direction in which a light beam is incident to a light splitting device from a top-view direction as a reference.

Unless the context clearly requires otherwise, throughout the specification and the claims, technical and scientific terms used herein denote the meaning as commonly understood by a person skilled in the art. Additionally, the terms used in the specification of the present disclosure are merely for description of the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

In view of the case where the conventional head-up display device mounted on an automobile is only capable of displaying an image, but incapable of simultaneously displaying a close-up image and a distal image, and/or the case a two-dimensional image and a three-dimensional image need to be simultaneously displayed, embodiments of the present disclosure provide a projection optical system. In the projection optical system, light beams of images emitted by an image generation unit and light exiting from a light splitting device are controlled based on timing, such that the two different images are output through a first lens and a second lens respectively. In this way, different contents and images are respectively displayed at two different positions. In addition, the projection optical system according to the embodiments of the present disclosure has advantages of small size and low cost.

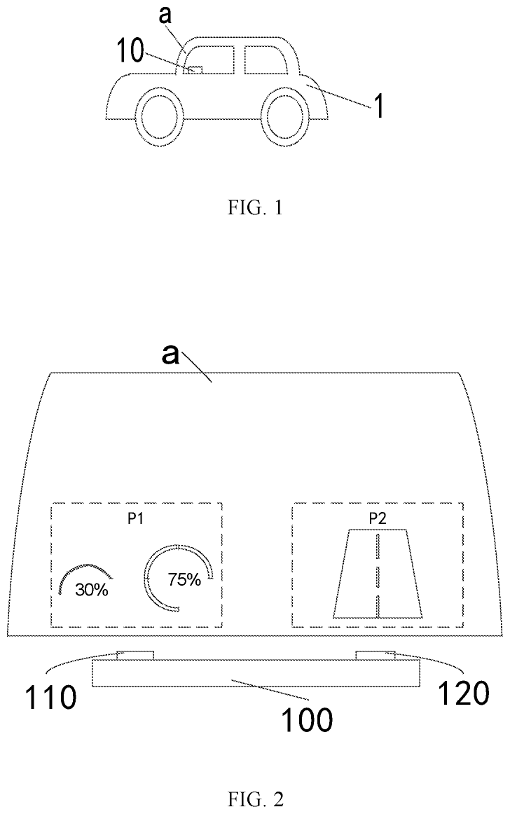

FIG. 1 is a schematic diagram of an application scenario of a projection optical system according to an embodiment of the present disclosure, and FIG. 2 is a schematic diagram of imaging on a front windshield in the application scenario in FIG. 1. The application scenario involves an automobile 1. The automobile 1 includes a front windshield a and a head-up display device 10.

The head-up display device 10 employs a projection optical system 100 according to the embodiment of the present disclosure to achieve imaging and display of two image pictures. The projection optical system 100 is capable of outputting a first image P1 and a second image P2 through a first lens 110 and a second lens 120 respectively.

In this application scenario, the first image P1 is mainly configured to display a two-dimensional image, for example, driving information of the automobile 1, wherein the driving information includes, but is not limited to, speed information, oil supply information, and the like of the automobile 1. Accordingly, the automobile 1 should be equipped with a speed sensor, an oil supply sensor, and the like. Specifically, configurations of the two-dimensional image, the driving information of the automobile 1, and the corresponding sensor may be selected according to the actual needs, which are not limited to those in the application scenario of the present disclosure.

In this application scenario, the second image P2 is mainly configured to display a three-dimensional image, that is, an AR picture, for example, road condition information of a road where the automobile 1 is traveling, wherein the road condition information includes, but is not limited to, lanes, road lines, pedestrian crossings, obstacles, traffic lights, traffic sign boards, and the like. Accordingly, the automobile 1 should be equipped with a camera, a laser radar, and the like detection device. Further, where the automobile 1 is capable of implementing a navigation function, navigation indication information may also be over-displayed together with the road condition information. Specifically, configurations of the three-dimensional image, the road condition information of the road where the automobile 1 is traveling, and the corresponding detection device may be selected according to the actual needs, which are not limited to those in the application scenario of the present disclosure.

In this application scenario, the front windshield a is preferably made of a glass material that is capable of clearly achieving imaging and has a good light transmittance. Specifically, the material may be selected according to the actual needs, which is not limited to that in the application scenario of the present disclosure.

Hereinafter, the embodiments of the present disclosure are further illustrated with reference to the accompanying drawings.

### First Embodiment

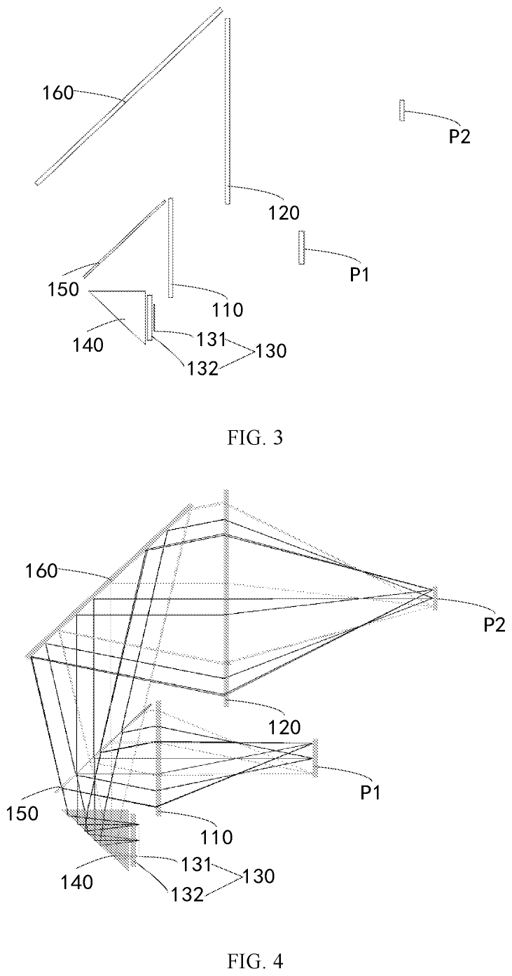

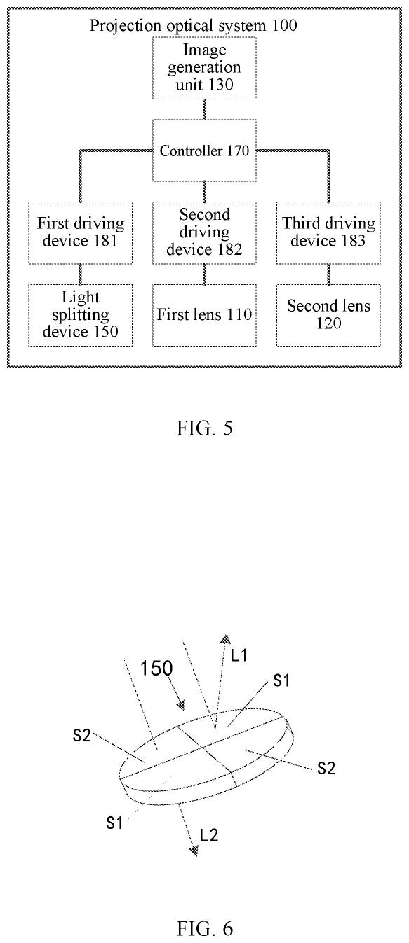

This embodiment of the present disclosure provides a projection optical system, which is applicable to a head-up display device as described in the above application scenario. Collectively referring to FIG. 3, FIG. 4, and FIG. 5, FIG. 3 is a structural diagram of a projection optical system 100 according to an embodiment of the present disclosure, FIG. 4 is a diagram of an optical path of the projection optical system in FIG. 3, and FIG. 5 is a structural block diagram of electrical connection of a projection optical system according to an embodiment of the present disclosure. The projection optical system 100 includes: a first lens 110, a second lens 120, an image generation unit 130, a first reflection unit 140, a light splitting device 150, a second reflection unit 160, a controller 170, a first driving device 181, a second driving device 182, and a third driving device 183.

The image generation unit 130 is configured to emit light beams including image information of a first image and a second image. The image generation unit 130 is a digital light processing (DLP) display chip or a liquid crystal on silicon (LCOS) display chip. In the embodiment of the present disclosure, the image generation unit 130 includes an effective surface 131 and a projective glass 132. In other embodiments, the image generation unit 130 may also be a digital micromirror device (DMD) display chip or another image display chip, which may be specifically selected according to the actual needs, and is not limited to that in the embodiment of the present disclosure.

A light incident side of the first reflection unit 140 is arranged in a light exit direction of the image generation unit 130. The first reflection unit 140 is a turning prism arranged at a first predetermined angle between the image generation unit 130 and the light splitting device 150. The turning prism employed by the first reflection unit 140 may be a total internal reflection (TIR) prism to achieve total reflection of the light beams. In the embodiment illustrated in FIG. 4, the first reflection unit 140 employs a right angle prism. One right angle face is opposite to the image generation unit 130. The other right angle face is opposite to the light splitting device 150. An inclined face of the first reflection unit 140 has a reflection angle of 90 degrees, that is, the first predetermined angle of the first reflection unit 140 is 45 degrees, and the first reflection unit 140 is arranged in the optical path at the predetermined angle. In some other embodiments, the model and material of the first reflection unit 140, and the first predetermined angle may be selected according to the actual needs, which are not limited to those in the embodiments of the present disclosure.

A light incident side of the light splitting device 150 is arranged in a light exit direction of a light reflection side of the first reflection unit 140; and the light splitting device 150 has an optical power of 52 mm. In the embodiment of the present disclosure, the light splitting device 150 is a device configured to split the light of the light beam of first image p1 and the light beam of the second image P2. The light splitting may be achieved by blocking or reflection, or by filtering or the like, which may be specifically configured according to the actual needs and is not limited to two shapes in FIG. 6 and FIG. 8 of the embodiments of the present disclosure. The light splitting device 150 may be made of an H-K9L colorless optical glass. In other embodiments, the material for manufacturing the light splitting device 150 and the color of the material may be selected according to the actual needs. Specifically, the material and the color of the material may be designed according to the actual needs, which are not limited to those in the embodiment and the drawing of the present disclosure.

It should be noted that the optical power of the light splitting device 150 is only a design parameter obtained by software simulation in the embodiment as illustrated in FIG. 4 of the present disclosure. In practice, according to different beam propagation paths, the specific design parameter of the light splitting device 150 may also be other parameters obtained according to software simulation. The examples according to the embodiments of the present disclosure are not intended to construe any limitation to the design parameter of the light splitting device 150 during the actual simulation or manufacturing.

In some embodiments, the first driving device 181 is connected to the controller 170 and the light splitting device 150, and configured to drive, in response to a control instruction issued by the controller 170, the light splitting device 150 to rotate. The light splitting device 150, in response to rotating to a first angle, is such configured that only the reflection region of the light splitting device 150 is arranged in a light exit direction of the first reflection unit 140 to reflect the light beam of the first image P1, or the light splitting device 150, in response to rotating to a second angle, is such configured that only the transmission region of the light splitting device 150 is arranged in a light exit direction of the second reflection unit 160 to transmit the light beam of the second image P2.

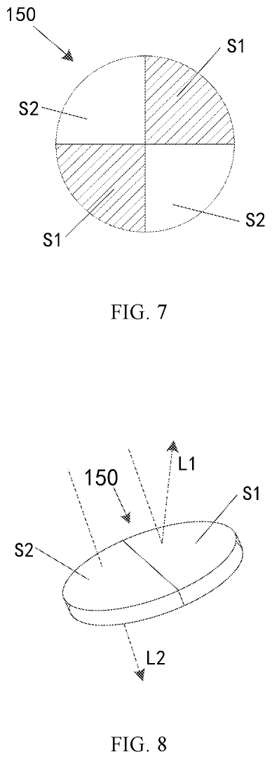

Further, referring to FIG. 6 and FIG. 7, FIG. 6 is a structural diagram of a light splitting device 150 according to an embodiment of the present disclosure, and FIG. 7 is a top view of the light splitting device 150 in FIG. 6. In the light splitting device 150, an area of a transmission region S2 is equal to an area of a reflection area S1 in a top view direction, and the light splitting device 150 is divided into two transmission regions S2 and two reflection regions S1. The two transmission regions S2 are arranged in a zig-zag configuration, and the two reflection regions S1 are arranged in a zig-zag configuration.

Further, referring to FIG. 8 and FIG. 9, FIG. 8 is a structural diagram of another light splitting device 150 according to an embodiment of the present disclosure, and FIG. 9 is a top view of the light splitting device 150 in FIG. 8. In the light splitting device 150, an area of a transmission region S2 is equal to an area of a reflection area S1 in a top view direction, and the light splitting device 150 is divided into one transmission region S2 and one reflection region S1.

Further, based on the embodiments illustrated in FIG. 6, FIG. 7, FIG. 8, and FIG. 9, in order that all of a light beam L1 of the first image is reflected, the reflection region S1 is coated with a highly reflective film configured to reflect the light beam L1 of the first image, that is, a film stack capable of reflecting a wavelength of the light beam L1 of the first image to totally reflect the light beam L1 of the first image. In order that all of a light beam L2 of the second image is transmitted, the transmission region S2 is coated with an anti-reflection film configured to transmit the light beam L2 of the second image, that is, a film stack capable of transmitting a wavelength of the light beam L2 of the second image to totally transmit the light beam L2 of the second image. Further, the transmission region S2 may also be hollowed out to achieve total transmission. However, this may result in a situation where undesired stray light enters the optical modules. Therefore, the anti-reflection film is coated to achieve total transmission.

It should be noted that the area, size, position, film coating, film stack for coating, hollowing out or not, and the like of the reflection region S1 and the transmission region S2 of the light splitting device 150 may be configured according to the actual needs, which are not limited to those in the embodiments illustrated in FIG. 6, FIG. 7, FIG. 8, and FIG. 9 of the present disclosure.

A light incident side of the first lens 110 is arranged in a light exit direction of a light reflection side of the light splitting device 150; and the first lens 110 has an optical power of 24 mm, and the first lens 110 has a focal length of 15.4 mm. Specifically, the first lens 110 may be a single lens or a lens group composed of a plurality of lenses, and may also contain other optical instruments. In practical application scenarios, the first lens 110 may be configured according to the actual needs, which is not limited to that in the embodiment of the present disclosure. It should be noted that the optical power and focal length of the first lens 110 are only design parameters obtained by software simulation in the embodiment as illustrated in FIG. 4 of the present disclosure. In practice, depending on different beam propagation paths, the specific design parameters of the first lens 110 may also be other parameters obtained according to software simulation. The examples according to the embodiments of the present disclosure are not intended to construe any limitation to the design parameters of the first lens 110 during the actual simulation or manufacturing.

Alight incident side of the second reflection unit 160 is arranged in a light exit direction of a light transmission side of the light splitting device 150. The second reflection unit 160 is a mirror arranged at a second predetermined angle between the light splitting device 150 and the second lens 120. The second reflection unit 160 may also include a highly reflective film coated on the mirror to achieve total reflection of the light beams. In the embodiment illustrated in FIG. 4, an inclined face of the second reflection unit 160 has a reflection angle of 90 degrees, that is, the second predetermined angle of the second reflection unit 160 is 45 degrees, and the second reflection unit 160 is arranged in the optical path at the predetermined angle. In some other embodiments, the model and material of the second reflection unit 160, and the second predetermined angle may be selected according to the actual needs, which are not limited to those in the embodiment of the present disclosure.

A light incident side of the second lens 120 is arranged in a light exit direction of a light reflection side of the second reflection unit 160; and the second lens 120 has an optical power of 45 mm, and the second lens 120 has a focal length of 26.4 mm. Specifically, the second lens 120 may be a single lens or a lens group composed of a plurality of lenses, and may also contain other optical instruments. In practical application scenarios, the second lens 120 may be configured according to the actual needs, which is not limited to that in the embodiment of the present disclosure. It should be noted that the optical power and focal length of the second lens 120 are only design parameters obtained by software simulation in the embodiment as illustrated in FIG. 4 of the present disclosure. In practice, according to different beam propagation paths, the specific design parameters of the second lens 120 may also be other parameters obtained according to software simulation. The examples according to the embodiments of the present disclosure are not intended to construe any limitation to the design parameters of the second lens 120 during the actual simulation or manufacturing.

The projection optical system 100, according to the embodiment of the present disclosure, manufactured by using the above mentioned design parameters, has a size that may be wholly controlled within 85 mm*85 mm in horizontal and vertical lengths in the direction as illustrated in FIG. 3. A width at a maximum position may be controlled within 52 mm in the width perpendicular to the image as illustrated in FIG. 3. Therefore, the projection optical system 100 is relatively small in size with respect to the conventional projection optical system applicable to the head-up display device mounted on an automobile.

The controller 170 is connected to the image generation unit 130 and the light splitting device 150, and configured to control, based on timing, an image emitted by the image generation unit 130 and light exiting from the light splitting device 150. The controller 170 is configured to control, in response to controlling the image generation unit 130 to emit the first image P1, the light to exit only from the light reflection side of the light splitting device 150, such that the first image P1 is emitted and imaged through the first lens 110; or the controller 170 is configured to control, in response to controlling the image generation unit 130 to emit the second image P2, the light to exit only from the light transmission side of the light splitting device 150, such that the second image P2 is emitted and imaged through the second lens 120. The controller 170 may be various types of chips, modules, units, apparatuses and/or devices with a computing function, such as a processor and a server, commonly used for optical projection and capable of sending a control instruction. Further, the controller 170 may also have a computing function and/or a control function that projection devices usually have, such as communicating with the outside and/or accepting user gesture actions or instructions, and the like. Specifically, a corresponding controller 170 may be selected according to the actual needs, which is not limited to the embodiment of the present disclosure.

As described in the above application scenario, the automobile 1 further includes a front windshield a, and in the projection optical system 100, relay images of the first lens 110 and the second lens 120 are imaged on the front windshield a. In the embodiment of the present disclosure, the controller 170 is further connected to the first lens 110 and the second lens 120, and configured to adjust, by controlling positions of the first lens 110 and the second lens 120, a virtual image distance between the first image P1 and the second image P2 in response to the first image P1 and the second image P2 being imaged on the front windshield a. Specifically, the second driving device 182 is connected to the controller 170 and the first lens 110, and configured to drive, in response to a control instruction issued by the controller 170, the first lens 110 to adjust an imaging position of light exiting from the first lens; and the third driving device 183 is connected to the controller 170 and the second lens 120, and configured to drive, in response to a control instruction issued by the controller 170, the second lens to adjust an imaging position of light exiting from the second lens 120.

In the case of displaying two images using the projection optical system according to the embodiment of the present disclosure, using the application scenarios illustrated in FIG. 1 and FIG. 2 as examples, during a time period from t1 to t2, the image generation unit 130 plays the first image P1, and the light splitting device 150 blocks the light, such that the light is reflected to the first lens 110 to display the first image P1; during a time period from t2 to t3, the image generation unit 130 plays the second image P2, the light splitting device 150 does not block the light, and the light reaches the second lens 120 to display the second image P2; then, by repeating the above steps during the above time periods, the image generation unit 130 cyclically plays the first image P1 and the second image P2, and meanwhile the light exiting from the light splitting device 150 is cyclically controlled. Preferably, in order that human eyes see that the first image P1 and the second image P2 are displayed simultaneously, play time of the first image P1 (t2−t1) and play time of the second image P2 (t3−t2) may be controlled within 0.1 to 0.4 seconds by using the phenomenon of persistence of vision, such that different display contents and pictures are played and displayed by means of timing control. Further, the distance of the virtual image presented on the front windshield a may also be adjusted by adjusting the focal lengths, or positions of the first lens 110 and the second lens 120, or even by using lenses of different magnifications, or the like.

It should be noted that the first driving device 181, the second driving device 182 and/or the third driving device 183 may respectively drive the light splitting device 150, the first lens 110 and/or the second lens 120 mechanically, may respectively drive the light splitting device 150, the first lens 110 and/or the second lens 120 in a software drive fashion, or may respectively drive the light splitting device 150, the first lens 110 and/or the second lens 120 in a software-plus-hardware fashion. For example, these elements are driven by using a servo/a motor, or driven by wired/wireless connection between the controller 170 and a server/a system/an electronic device, or driven by using a switch transistor/a switch circuit, and the like. Specifically, configurations may be made according to the actual needs, which are not limited to those in the embodiment of the present disclosure.

### Second Embodiment

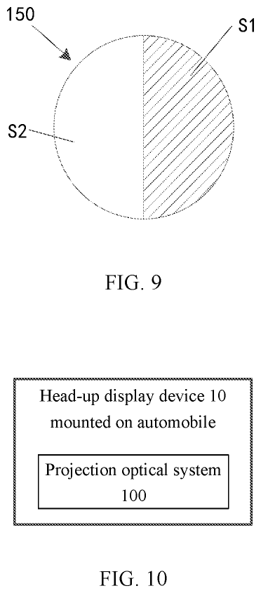

This embodiment of the present disclosure provides a head-up display device mounted on an automobile. The automobile may be the automobile 10 as described in the above mentioned application scenario, and the head-up display device may be the head-up device as described in the above mentioned application scenario. Referring to FIG. 10, a structure of a head-up display device 10 mounted on an automobile according to an embodiment of the present disclosure is illustrated. The head-up display device 10 includes the projection optical system 100 as described in the first embodiment, wherein the projection optical system 100 is capable of projecting the first image P1 and/or the second image P2 onto the front windshield a of the automobile 10 to achieve imaging.

It should be noted that the specific structure of the projection optical system 100 is as described in the first embodiment, and reference may be made to the description of the projection optical system 100 in the first embodiment, which is not described in detail herein.

The embodiments of the present disclosure provide a projection optical system applicable to a head-up display device mounted on an automobile. The projection optical system includes an image generation unit, a first reflection unit, a light splitting device, a first lens, a second reflection unit, and a second lens that are successively arranged in a light exit direction; and further includes a controller connected to the image generation unit and the light splitting device, and configured to control, based on timing, an image emitted from the image generation unit and light exiting from the light splitting device; wherein the light splitting device is in a disc shape in a top view direction and includes a transmission region and a reflection region; and the controller is configured to, in response to controlling the image generation unit to emit the first image, control the light to exit only from the reflection region of the light splitting device, such that the first image is emitted and imaged through the first lens, or the controller is configured to, in response to controlling the image generation unit to emit the second image, control the light to exit only from the transmission region of the light splitting device, such that the second image is emitted and imaged through the second lens. The projection optical system according to the present disclosure is capable of displaying, by means of timing control, different contents and pictures at two different positions, and in addition, the system has advantages of small size and low cost.

It should be noted that the above described device embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objectives of the technical solutions of the embodiments.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A projection optical system, applicable to a head-up display device mounted on an automobile, the system comprising:
an image generation unit, configured to emit light beams comprising image information of a first image and a second image;
a first reflection unit, a light incident side of the first reflection unit being arranged in a light exit direction of the image generation unit;
a light splitting device, a light incident side of the light splitting device being arranged in a light exit direction of a light reflection side of the first reflection unit, and the light splitting device being in a disc shape in a top view direction and including a transmission region and a reflection region;
a first lens, a light incident side of the first lens being arranged in a light exit direction of a light reflection side of the light splitting device;
a second reflection unit, a light incident side of the second reflection unit being arranged in a light exit direction of a light transmission side of the light splitting device;
a second lens, a light incident side of the second lens being arranged in a light exit direction of a light reflection side of the second reflection unit; and
a controller, connected to the image generation unit and the light splitting device, and configured to control, based on timing, an image emitted from the image generation unit and light exiting from the light splitting device; wherein
the controller is configured to control, in response to controlling the image generation unit to emit the first image, the light to exit from only the reflection region of the light splitting device, such that the first image is emitted and imaged through the first lens, or
the controller is configured to control, in response to controlling the image generation unit to emit the second image, the light to exit only from the transmission region of the light splitting device, such that the second image is emitted and imaged through the second lens.

2. The projection optical system according to claim 1, further comprising:
a first driving device, connected to the controller and the light splitting device, and configured to drive, in response to a control instruction issued by the controller, the light splitting device to rotate;
the light splitting device, in response to rotating to a first angle, is such configured that only the reflection region of the light splitting device is arranged in a light exit direction of the first reflection unit to reflect the light beam of the first image, or
the light splitting device, in response to rotating to a second angle, is such configured that only the transmission region of the light splitting device is arranged in a light exit direction of the second reflection unit to transmit the light beam of the second image.

3. The projection optical system according to claim 1, wherein
in the light splitting device, an area of the transmission region is equal to an area of the reflection region in a top view direction; and
the light splitting device is divided into two transmission regions and two reflection regions, wherein the two transmission regions are arranged in a zig-zag configuration, and the two reflection regions are arranged in a zig-zag configuration,
or,
the light splitting device is divided into one transmission region and one reflection region.

4. The projection optical system according to claim 1, wherein
the reflection region is provided with a highly reflective film configured to reflect the light beam of the first image, and the transmission region is provided with an anti-reflection film configured to transmit the light beam of the second image.

5. The projection optical system according to claim 1, wherein
the first reflection unit is a turning prism arranged at a first predetermined angle between the image generation unit and the light splitting device; and
the second reflection unit is a mirror arranged at a second predetermined angle between the light splitting device and the second lens.

6. The projection optical system according to claim 2, wherein
the first reflection unit is a turning prism arranged at a first predetermined angle between the image generation unit and the light splitting device; and
the second reflection unit is a mirror arranged at a second predetermined angle between the light splitting device and the second lens.

7. The projection optical system according to claim 3, wherein
the first reflection unit is a turning prism arranged at a first predetermined angle between the image generation unit and the light splitting device; and
the second reflection unit is a mirror arranged at a second predetermined angle between the light splitting device and the second lens.

8. The projection optical system according to claim 4, wherein
the first reflection unit is a turning prism arranged at a first predetermined angle between the image generation unit and the light splitting device; and
the second reflection unit is a mirror arranged at a second predetermined angle between the light splitting device and the second lens.

9. The projection optical system according to claim 5, wherein
the automobile further comprises a front windshield, wherein the front windshield is a diffuser, and in the projection optical system, relay images of the first lens and the second lens are imaged on the front windshield; and
the controller is further connected to the first lens and the second lens, and configured to adjust, by controlling positions of the first lens and the second lens, a virtual image distance between the first image and the second image in response to the first image and the second image being imaged on the front windshield.

10. The projection optical system according to claim 9, further comprising:
a second driving device, connected to the controller and the first lens, and configured to drive, in response to a control instruction issued by the controller, the first lens to adjust an imaging position of light exiting from the first lens; and
a third driving device, connected to the controller and the second lens, and configured to drive, in response to a control instruction issued by the controller, the second lens to adjust an imaging position of light exiting from the second lens.

11. The projection optical system according to claim 10, wherein
an optical power of the first lens is 24 mm, and a focal length of the first lens is 15.4 mm; and
an optical power of the second lens is 45 mm, and a focal length of the second lens is 26.4 mm.

12. The projection optical system according to claim 11, wherein an optical power of the light splitting device is 52 mm.

13. A head-up display device mounted on an automobile, comprising a projection optical system, wherein the projection optical system comprises:
an image generation unit, configured to emit light beams comprising image information of a first image and a second image;
a first reflection unit, a light incident side of the first reflection unit being arranged in a light exit direction of the image generation unit;
a light splitting device, a light incident side of the light splitting device being arranged in a light exit direction of a light reflection side of the first reflection unit, and the light splitting device being in a disc shape in a top view direction and including a transmission region and a reflection region;
a first lens, a light incident side of the first lens being arranged in a light exit direction of a light reflection side of the light splitting device;
a second reflection unit, a light incident side of the second reflection unit being arranged in a light exit direction of a light transmission side of the light splitting device;
a second lens, a light incident side of the second lens being arranged in a light exit direction of a light reflection side of the second reflection unit; and
a controller, connected to the image generation unit and the light splitting device, and configured to control, based on timing, an image emitted from the image generation unit and light exiting from the light splitting device; wherein
the controller is configured to control, in response to controlling the image generation unit to emit the first image, the light to exit from only the reflection region of the light splitting device, such that the first image is emitted and imaged through the first lens, or
the controller is configured to control, in response to controlling the image generation unit to emit the second image, the light to exit only from the transmission region of the light splitting device, such that the second image is emitted and imaged through the second lens, wherein
the projection optical system is capable of projecting the first image and/or the second image onto a front windshield of the automobile such that imaging is achieved on the front windshield.

14. The head-up display device mounted on an automobile according to claim 13, wherein the projection optical system further comprising:
a first driving device, connected to the controller and the light splitting device, and configured to drive, in response to a control instruction issued by the controller, the light splitting device to rotate;
the light splitting device, in response to rotating to a first angle, is such configured that only the reflection region of the light splitting device is arranged in a light exit direction of the first reflection unit to reflect the light beam of the first image, or
the light splitting device, in response to rotating to a second angle, is such configured that only the transmission region of the light splitting device is arranged in a light exit direction of the second reflection unit to transmit the light beam of the second image.

15. The head-up display device mounted on an automobile according to claim 13, wherein
in the light splitting device, an area of the transmission region is equal to an area of the reflection region in a top view direction; and
the light splitting device is divided into two transmission regions and two reflection regions, wherein the two transmission regions are arranged in a zig-zag configuration, and the two reflection regions are arranged in a zig-zag configuration,
or,
the light splitting device is divided into one transmission region and one reflection region.

16. The head-up display device mounted on an automobile according to claim 13, wherein
the reflection region is provided with a highly reflective film configured to reflect the light beam of the first image, and the transmission region is provided with an anti-reflection film configured to transmit the light beam of the second image.

17. The head-up display device mounted on an automobile according to claim 13, wherein
the first reflection unit is a turning prism arranged at a first predetermined angle between the image generation unit and the light splitting device; and
the second reflection unit is a mirror arranged at a second predetermined angle between the light splitting device and the second lens.

18. The head-up display device mounted on an automobile according to claim 14, wherein
the first reflection unit is a turning prism arranged at a first predetermined angle between the image generation unit and the light splitting device; and
the second reflection unit is a mirror arranged at a second predetermined angle between the light splitting device and the second lens.

19. The head-up display device mounted on an automobile according to claim 15, wherein
the first reflection unit is a turning prism arranged at a first predetermined angle between the image generation unit and the light splitting device; and
the second reflection unit is a mirror arranged at a second predetermined angle between the light splitting device and the second lens.

20. The head-up display device mounted on an automobile according to claim 16, wherein
the first reflection unit is a turning prism arranged at a first predetermined angle between the image generation unit and the light splitting device; and
the second reflection unit is a mirror arranged at a second predetermined angle between the light splitting device and the second lens.
